(19) United States
(12) Patent Application Publication
(10) Pub. No.: US 2015/0170362 A1
(43) Pub. Date: Jun. 18, 2015

(54) METHOD AND USER INTERFACE TO PROCESS AN IMAGE DATA SET

(71) Applicant: SIEMENS AKTIENGESELLSCHAFT, Muenchen (DE)

(72) Inventors: Maria Kroell, Erlangen (DE); Daniel Rinck, Forchheim (DE)

(73) Assignee: SIEMENS AKTIENGESELLSCHAFT, Muenchen (DE)

(21) Appl. No.: 14/575,046

(22) Filed: Dec. 18, 2014

(30) Foreign Application Priority Data
Dec. 18, 2013 (DE) 102013226332.5

(51) Int. Cl. G06T 7/00

(52) U.S. Cl. CPC G06T 7/0012; G06T 2207/10004; G06T 2207/10116; G06T 2210/41

(57) ABSTRACT

In a method a user interface, and a medical imaging apparatus for processing an image data set, in particular a medical image data set, in order to enable a reproducible protocoling of the processing of an image data set, the following steps are implemented. An image data set is provided to a computer at a first point in time. Presentation parameters and/or evaluation parameters for the image data set are selected and entered into the computer, and a preparation of the image data set takes place using the selected and entered presentation parameters and/or evaluation parameters. The selected presentation parameters and/or evaluation parameters are protocoled in the computer. The image data set and the protocoled presentation parameters and/or evaluation parameters are provided at the same computer or at a different computer at a second point in time that is chronologically after the first point in time.

### BACKGROUND OF THE INVENTION

1. Field of the Invention

The invention concerns a method to process an image data set, in particular a medical image data set, as well as a user interface and a medical imaging apparatus for implementing such a method.

2. Description of the Prior Art

To process an image data set, presentation parameters (for presentation of the image data set at a display unit) or evaluation parameters (which typically establish evaluation steps and/or further processing steps for the image data set) are often selected.

It is often difficult to reproduce the course of the selection of the presentation parameters and/or evaluation parameters even though this is regularly necessary, for example to assess the quality of the implemented processing of the image data set. Typically, only the result of the processing or evaluation of the image data set can be assessed.

For example, it is often the case that the processing of a medical image data set should be assessed by a first radiologist (for example a radiologist in training) and by a second radiologist (for example an experienced radiologist). For this purpose, the first radiologist typically must implement the selection of the presentation parameters and/or evaluation parameters again from memory in the presence of the second radiologist, such that the second radiologist can assess the work of the first radiologist.

### SUMMARY OF THE INVENTION

An object of the invention is to enable a reproducible protocoling of the processing of an image data set.

The invention proceeds from a method to process an image data set, in particular a medical image data set, that includes the following method steps:
provide an image data set at a first point in time,
select presentation parameters and/or evaluation parameters for the image data set, wherein a preparation of the image data set takes place using the presentation parameters and/or evaluation parameters,
protocol the selected presentation parameters and/or evaluation parameters,
provide the image data set and provide the protocoled presentation parameters and/or evaluation parameters at a second point in time which is chronologically after the first point in time.

The provision of the image data set at the first and/or second point in time can include an acquisition of the image data set, in particular by operation of a medical imaging apparatus. Alternatively or additionally, the acquisition of the image data set can include loading of the image data set (from a database, for example).

The provision of the image data set at the first point in time typically takes place for a first user, in particular at a first user interface. The provision of the image data set and provision of the protocoled presentation parameters and/or evaluation parameters at the second point in time typically takes place for a second user, in particular at a second user interface. The second user can be different than the first user. The second user can also be the same as the first user. For example, the first user can be a first radiologist, wherein the second user can then be a second radiologist. The second user interface can likewise be different than the first user interface. The second user interface can also be formed at a computer system that is physically separated (in particular located at a different location) from the first user interface.

The selection of the presentation parameters and/or evaluation parameters for the image data set is preferably performed by a user, in particular the first user. Presentation parameters are typically settings to display the image data set at a display unit. Evaluation parameters thereby typically include settings which specify a further processing of the image data set. Alternatively or additionally, evaluation parameters can also specify in what manner the image data set should be evaluated to extract information included in the image data set.

The preparation of the image data set using the presentation parameters and/or evaluation parameters typically takes place by operation of a computer, preferably automatically. The preparation of the image data set using the presentation parameters preferably includes a display of image data of the image data set at a display unit (for example a monitor) depending on the selected presentation parameters. The preparation of the image data set using the evaluation parameters typically includes a preparation and/or modification of image data of the image data set depending on the selected evaluation parameters. Alternatively or additionally, the preparation of the image data set using the evaluation parameters can include an extraction of information included in the image data set depending on the selected evaluation parameters.

The protocoling of the selected presentation parameters and/or evaluation parameters typically includes a recording of the presentation parameters and/or evaluation parameters. Furthermore, the protocoling of the selected presentation parameters and/or evaluation parameters in particular includes a storage of the protocoled presentation parameters and/or evaluation parameters, in particular in a database. The storage of the protocoled presentation parameters and/or evaluation parameters thereby advantageously includes a storage of user-specific settings, in particular during the selection of the presentation parameters and/or evaluation parameters. The protocoled presentation parameters and/or evaluation parameters can be stored as pointer objects in the image data set, such that the provision of the protocoled presentation parameters and/or evaluation parameters includes loading of the pointer objects, which is possible separately from the loading of the image data set at the second point in time.

The proposed procedure enables a reproducible protocoling of the processing of the image data set at a first point in time, in particular using the selection of the presentation parameters and/or evaluation parameters for the image data set by a first user. A second user (who is possibly different than the first user) can reproduce the processing of the image data set by a first user at a second point in time, chronologically (and in particular spatially) separate from the first user. For example, the second user can thus ensure that the processing of the image data set by the first user has been implemented efficiently, thoroughly and correctly. The reproduction of the processing of the image data set can thereby take place in a structured manner. The second user can give the first user feedback with regard to the processing of the image data set.

The inventive method is particularly advantageous with regard to the example of protocoling processing (in particular a viewing and/or evaluation) of a medical image data set by a first radiologist, in particular a radiologist in training. The presentation parameters and/or evaluation parameters that are selected by the first radiologist can be provided to the second radiologist (in particular the experienced radiologist) for supervision. The second radiologist can then reproduce the processing steps of the first radiologist and ensure that the first radiologist
has not overlooked any important information in the image data set,
has used an advantageous and structured procedure in the processing and/or assessment of the image data set,
has considered all relevant image data of the image data set and/or
has considered the image data of the image data set in a significant presentation, in particular using the correct slice presentations and/or display parameters.

In particular, the inventive procedure enables the second radiologist to be able to implement the assessment of the work of the first radiologist chronologically and/or spatially independently of the first radiologist. The supervision of the processing of the medical image data set can thus be implemented particularly efficiently since no coordination (for example an appointment) between the first radiologist and second radiologist is required. A time savings can therefore be achieved for the first radiologist and second radiologist. Furthermore, the (in particular automatic) protocoling of the selected presentation parameters and/or evaluation parameters is not susceptible to error, in particular in contrast to the repeated implementation of the processing steps using the recollection of the first radiologist. A particularly high quality of the processing and/or assessment of the (in particular medical) image data set can thus be ensured.

In an embodiment, the selection of the presentation parameters and/or evaluation parameters takes place according to a time sequence, and the protocoling of the presentation parameters and/or evaluation parameters includes a protocoling of the time sequence of the selection of the presentation parameters and/or evaluation parameters. The selection of the presentation parameters and/or evaluation parameters according to a time sequence means that the presentation parameters and/or evaluation parameters are selected in chronological succession, in particular by a first user. Alternatively or additionally, the time sequence of the selection of the presentation parameters and/or evaluation parameters can also represent a chronological order of the selection of the presentation parameters and/or evaluation parameters. The chronological order is then particularly significant in the protocoling of the time sequence. The protocoling of the time sequence of the selection of the presentation parameters and/or evaluation parameters can include the protocoling of the selected presentation parameters and/or evaluation parameters together with associated time specifications and/or timestamps. Alternatively or additionally, the protocoling of the time sequence of the selection of the presentation parameters and/or evaluation parameters can include the protocoling of the selected presentation parameters and/or evaluation parameters together with meta-information which, for example, specifies an order of the selection of the presentation parameters and/or evaluation parameters. In particular, a provision of the protocoled time sequence of the selection of the presentation parameters and/or evaluation parameters takes place at a second point given provision of the image data set and provision of the protocoled presentation parameters and/or evaluation parameters. This offers the possibility (in particular to the second user) to reproduce the presentation parameters and/or evaluation parameters that were selected (in particular by the first user) using the time sequence of the selection of the presentation parameters and/or evaluation parameters. It is particularly advantageous to monitor a logical and/or structured procedure that was used in the selection of the presentation parameters and/or evaluation parameters, for example whether the image data of the image data set were considered in the correct order.

In another embodiment, the provided protocoled presentation parameters and/or evaluation parameters are modified. In particular, the provided protocoled presentation parameters and/or evaluation parameters are modified after the second point in time and/or by the second user. In particular, the modification of the provided protocoled presentation parameters and/or evaluation parameters can be provided to the first user as a feedback (for example a written feedback). The feedback can be given precisely at the processing step (i.e. the selection of the presentation parameters and/or evaluation parameters) to which the feedback belongs. The modification of the provided protocoled presentation parameters and/or evaluation parameters can also include a correction of the provided protocoled presentation parameters and/or evaluation parameters. For example, processing—in particular an incorrect processing step—by the first user can be corrected particularly simply by the second user using the protocoling. The correction can be provided to the first user again as a feedback. Furthermore, an alternative presentation parameter and/or evaluation parameter can be selected. The modification of the provided protocoled presentation parameters and/or evaluation parameters is particularly advantageous in combination with the noted protocoling of the time sequence of the selection of the presentation parameters and/or evaluation parameters. The modification of the provided protocoled presentation parameters and/or evaluation parameters can take place at an initial point (in particular a processing point and/or point in time) within the protocoled time sequence of the selection of the presentation parameters and/or evaluation parameters. This means that the preparation of the image data set using the presentation parameters and/or evaluation parameters selected within the protocoled time sequence before the initial point is considered as given for the modification of the provided protocoled presentation parameters and/or evaluation parameters. Given the modification of the provided protocoled presentation parameters and/or evaluation parameters, the second user can accordingly select an arbitrary initial point within the protocoled time sequence, and thus can comfortably implement a modification of the processing of the image data set. Here as well, a provision of a feedback for the first user is possible again, for example in that a new initial point for the first user is set within the protocoled time sequence, as of which new initial point he or she should implement a new (in particular improved) selection of presentation parameters and/or evaluation parameters.

In another embodiment, the image data set is prepared again according to the modified presentation parameters and/or evaluation parameters. It is particularly advantageous for the image data set to be prepared again according to the modification of the presentation parameters and/or evaluation parameters in combination with the noted protocoling of the time sequence of the selection of the presentation parameters and/or evaluation parameters. A modification of the presentation parameters and/or evaluation parameters is hereby advantageously implemented by the second user at an initial point within the time sequence. The new preparation of the image data set then advantageously takes place according to the modification of the presentation parameters and/or evaluation parameters and according to the presentation parameters and/or evaluation parameters that in particular have already been selected by the first user after the initial point. The processing of the image data set that is implemented according to the time sequence after the modification of the image data set is thus implemented again automatically, in particular under consideration of the modification of the processing of the image data set. The effects of a modification of the presentation parameters and/or evaluation parameters can thereby be quantified and/or depicted particularly comfortably. For example, on the basis of a segmentation of a region of the image data set, multiple evaluation steps for the segmented region are selected by the first user. The proposed method now enables a second user to make a modification of the segmentation of the region, wherein the following evaluation steps can then be executed again automatically for the modified, segmented region.

In another embodiment, the selection of the presentation parameters includes a selection of image data of the image data set that are to be displayed. In particular, what is thereby meant is that the first user selects which image data (in particular images) of the image data set he wants to view. The preparation using the selection of the image data to be displayed then preferably takes place such that the selected image data are displayed on a display unit (a monitor, for example). In particular, the sequence and/or order of the image data to be displayed can be selected and protocoled again. Multiple image data of the image data set can also be displayed simultaneously, in particular in multiple windows of the monitor, for example in order to conduct a comparison of the image data. The image data can be slice images of the image data set. The selection of the image data to be displayed can then include a selection of the slice images and/or of the alignment (in particular the slice plane) of the slice images. For example, if image data acquired with different imaging modalities and/or imaging settings are present, the selection of the image data to be displayed can also include a selection of image data of a specific imaging modality and/or image data with specific imaging settings. The protocoling of the selection of the image data of the image data set that is to be displayed is particularly advantageous, because it allows tracking as to whether the correct image data of the image data set have been viewed and/or whether any image data of the image data set have been overlooked.

In another embodiment, the selection of the presentation parameters includes a selection of a display setting for the image data set. As used herein, the selection of the display setting means the selection of a type of display (in particular a presentation type) of the image data of the image data set at the display unit. For example, a two-dimensional or three-dimensional presentation of the image data can fall under this. A maximum intensity projection (MIP) for the image data can also be selected and/or a volume visualization (volume rendering technique, VRT) can be implemented. In particular, a selection of the layout of the image data at the display unit and/or a selection of synchronization settings for the comparison of multiple image data of the image data set can also fall under the selection of the display settings. The protocoling of the selection of the display setting for the image data set is advantageous because it allows tracking as to whether the image data of the image data set have been viewed in a correct and/or meaningful presentation, for example so that no image content of the image data have been overlooked.

In another embodiment, the selection of the presentation parameters includes a selection of a greyscale value map and/or color palette for the image data set. The selection of a color index and/or a color table (color lookup table, LUT) are also encompassed by this. It is useful to protocol the selection of the windowing of the greyscale value map and/or of the color palette (in particular the selection of possible thresholds for the windowing) for presentation of the image data of the image data set. It can therefore also be ensured by the second user that a meaningful windowing has been used for the presentation of the image data, and (for example) that no relevant image content of the image data have been windowed.

In another embodiment, the selection of the evaluation parameters includes a segmentation of the image data set. The segmentation of the image data set is typically implemented by the first user and/or automatically, in particular on the basis of specifications of the first user. The segmentation of the image data set—in particular of the image data of the image data set—typically includes the selection of at least one (in particular two-dimensional or three-dimensional) region in the image data set. On the basis of the segmentation of the image data, an (in particular automatic) evaluation is then subsequently implemented for the at least one region, for example. For example, the evaluation can include the determination of a maximum signal value in the segmented volume of the image data. The procedure according to the invention offers the advantage that the segmentation of the image data set can be checked and assessed by the second user. The second user can then advantageously also make changes to the segmentation by the first user. The evaluation of the image data can then advantageously take place again according to the modified segmentation.

In another embodiment, the selection of the evaluation parameters includes a further processing of the image data set. Various possibilities for further processing of an image data set are known to those skilled in the art. Filtering, smoothing or scaling are examples of possible techniques for further processing of the image data set. More complex possibilities for further processing of the image data set are also known. For example, a perfusion map can be calculated for a medical image data set of the brain of an examined person. In particular, settings and/or specifications for the further processing of the image data set can be selected by the first user, wherein the settings and/or specifications can then be protocoled. The second user can then implement at least partial changes to the settings and/or specifications, wherein a new further processing of the image data set can take place based on the changes. With regard to the example of the calculation of the perfusion map, the correct positioning of an arterial input function by the first user (in particular by the first radiologist) in the image data set and the selection of matching measurement curves are particularly decisive. With regard to the procedure according to the invention, the positioning of the arterial input function and the selection of the measurement curves can be protocols and reproduced particularly simply by a second user. If necessary, this second user can make changes to the positioning and/or the selection, wherein the perfusion map can be recalculated particularly simply on the basis of these changes. The changes can also be provided to the first user as feedback. Naturally, additional processing steps of the image data set can also be additionally protocoled according to user-defined settings.

The user interface according to the invention has an image data acquisition unit, an input unit, a computer and a display unit, wherein
the image data acquisition unit is designed to provide an image data set at a first point in time,
the input unit is designed for selecting presentation parameters and/or evaluation parameters for the image data set,
the computer is designed to prepare the image data set using the presentation parameters and/or evaluation parameters, and for a protocoling of the selected presentation parameters and/or evaluation parameters, and
the display unit is designed to provide the image data set and to provide the protocoled presentation parameters and/or evaluation parameters at a second point in time which is chronologically after the first point in time.

The user interface can have additional control components which are necessary and/or advantageous for execution of a method according to the invention. The user interface can also be designed to send control signals to an (in particular medical) imaging apparatus and/or to receive and/or process control signals in order to execute a method according to the invention. For this, computer programs and additional software can be stored in a memory unit of the user interface, by means of which computer programs and additional software a processor of the user interface at least partially automatically controls and/or executes a method workflow of a method according to the invention.

The medical imaging apparatus according to the invention has a user interface according to the invention. The medical imaging apparatus according to the invention is therefore designed to execute a method according to the invention with the user interface.

The user interface can be integrated into the medical imaging apparatus. The user interface can also be installed separately from the medical imaging apparatus. The user interface can be connected with the medical imaging apparatus.

The advantages of the user interface and of the medical imaging apparatus according to the invention essentially correspond to the advantages of the method according to the invention explained above. Features, advantages or alternative embodiments that are noted with regard to the method are applicable to the user interface and the medical imaging apparatus as well.

### BRIEF DESCRIPTION OF THE DRAWINGS

FIG. 1 shows a medical imaging apparatus according to the invention, designed as a magnetic resonance apparatus, for execution of a method according to the invention.

FIG. 2 is a flowchart of an embodiment of the method according to the invention.

FIG. 3 is a flowchart of a more detailed embodiment of the method according to the invention.

### DESCRIPTION OF THE PREFERRED EMBODIMENTS

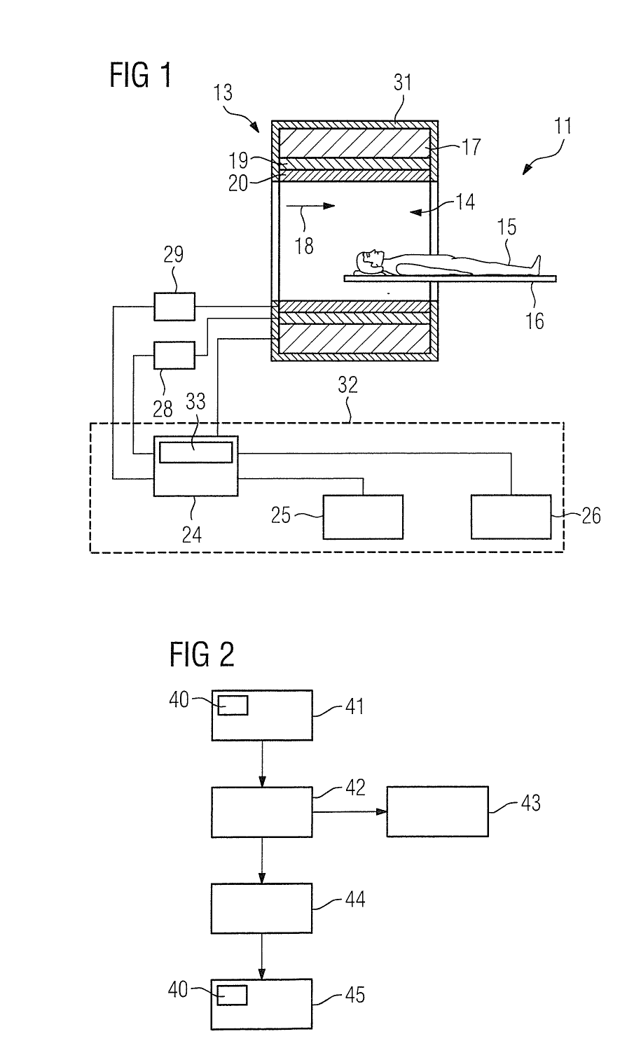

FIG. 1 shows a medical imaging apparatus 11 according to the invention, designed as a magnetic resonance apparatus 11, for execution of a method according to the invention. The medical imaging apparatus 11 can alternatively be a magnetic resonance apparatus, a single photon emission tomography apparatus (SPECT apparatus), a positron emission tomography apparatus (PET apparatus), a computed tomography apparatus, an ultrasound apparatus, an x-ray apparatus or a C-arm apparatus. It can also be a combined medical imaging apparatuses 11, which includes an arbitrary combination of the cited imaging modalities. In FIG. 1 through FIG. 3, the method according to the invention is presented using a magnetic resonance apparatus 11 merely for illustration.

The magnetic resonance apparatus 11 has a detector unit formed by a magnet unit 13, with a basic magnet 17 to generate a strong and in particular constant basic magnetic field 18. In addition to this, the magnetic resonance apparatus 11 has a cylindrical patient accommodation region 14 to accommodate a patient 15, wherein the patient accommodation region 14 is cylindrically enclosed by the magnet unit 13 in a circumferential direction. The patient 15 can be slid into the patient accommodation region 14 by a patient support device 16 of the magnetic resonance apparatus 11. For this, the patient bearing device 16 has a recumbent table that is arranged so as to be movable within the magnetic resonance apparatus 11. The magnet unit 13 is externally shielded by a housing (casing) 31 of the magnetic resonance apparatus.

Furthermore, the magnet unit 13 has a gradient coil unit 19 to generate magnetic field gradients that are used for a spatial coding during an imaging. The gradient coil unit 19 is controlled by means of a gradient control unit 28. Furthermore, the magnet unit 13 has a radio-frequency antenna unit 20 which in the shown case is fashioned as a body coil permanently integrated into the magnetic resonance apparatus 10, and a radio-frequency antenna control unit 29 to excite a polarization that arises in the basic magnetic field 18 generated by the basic magnet 17. The radio-frequency antenna unit 20 is controlled by the radio-frequency antenna control unit 29 and radiates radio-frequency magnetic resonance sequences into an examination space that is essentially formed by the patient accommodation region 14. The radio-frequency antenna unit 20 is furthermore designed to receive magnetic resonance signals, in particular from the patient 15.

The magnetic resonance apparatus 11 has a computer 24 to control the basic magnet 17, the gradient control unit 28 and the radio-frequency antenna control unit 29. The computer 24 centrally controls the magnetic resonance apparatus 11, for example the implementation of a predetermined imaging gradient echo sequence. Control information (for example imaging parameters) as well as reconstructed magnetic resonance images can be displayed to an operator at a display unit 25—for example on at least one monitor—of the magnetic resonance apparatus 11. In addition, the magnetic resonance apparatus 11 has an input unit 26 by means of which information and/or parameters can be entered by an operator during a measurement process and/or a display process of image data. The computer 24 can directly pass control commands to the gradient control unit 28 and the radio-frequency antenna control unit 29.

Furthermore, the magnetic resonance apparatus has a user interface 32 which comprises the input unit 26, the computer 24, an image data acquisition unit 33 and the display unit 25. The magnetic resonance apparatus 11—in particular the user interface 32 of the magnetic resonance apparatus 11—is thus designed to execute a method according to the invention. Deviating from the shown case, the user interface 32 is also designed to execute a method according to the invention separately from the magnetic resonance apparatus 11.

The shown magnetic resonance apparatus 11 can naturally include additional components that magnetic resonance apparatuses 11 conventionally have. The general functionality of a magnetic resonance apparatus 11 is known to the those skilled in the art, so that a more detailed description of the additional components is not necessary herein.

FIG. 2 shows a flowchart of an embodiment of the method according to the invention. In a first method step 41, a medical image data set 40 is provided at a first point in time by means of the image data acquisition unit 33. The medical image data set 40 can have been acquired earlier by operation of the magnetic resonance apparatus 11. Alternatively, an existing medical image data set 40 can be loaded from a database. In a further method step 42, a selection of presentation parameters and/or evaluation parameters for the medical image data set 40 takes place via the input unit 26, in particular is performed by a first user. Using the selected presentation parameters and/or evaluation parameters, in a further method step 43 a preparation of the medical image data set 40 takes place by means of the computer 24. In a further method step 44, a protocoling of the selected presentation parameters and/or evaluation parameters takes place by means of the computer 24. In a further method step 45, a provision of the medical image data set 40 and a provision of the protocoled presentation parameters and/or evaluation parameters takes place by means of the display unit 25 at a second point in time which is chronologically after the first point in time, in particular for a second user who can be identical to or different from the first user.

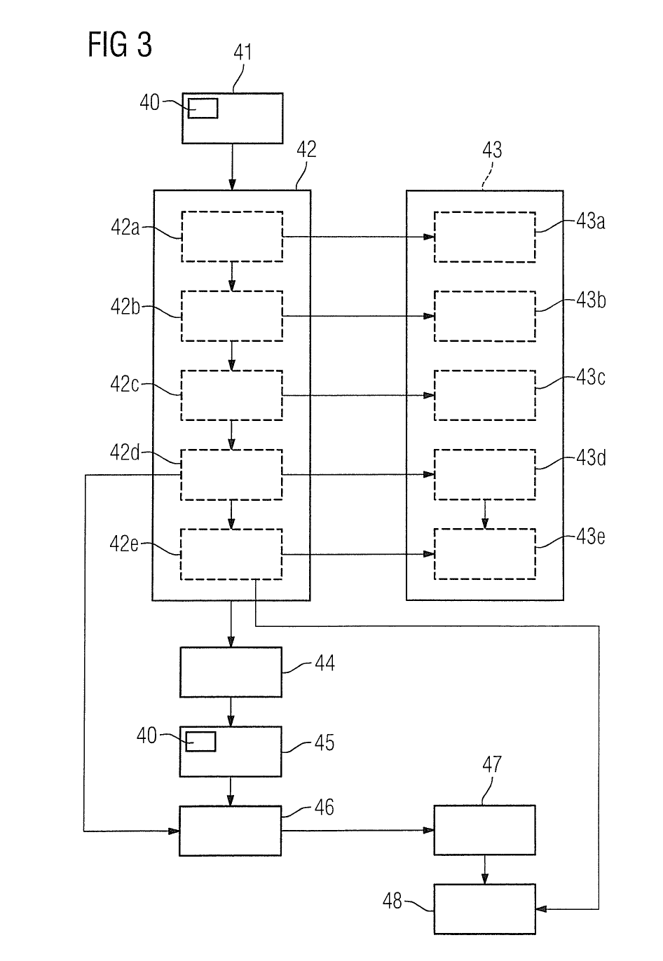

FIG. 3 shows a flowchart of a more detailed embodiment of the method according to the invention. The embodiment of the method according to the invention that is presented in FIG. 3 includes the method steps 40, 41, 42, 43, 44 and 45 of the embodiment of the method according to the invention that is shown in FIG. 2.

In the first method step 41, a medical image data set 40 is again provided at a first point in time by means of the image data acquisition unit 33. During the further method step 42 (the selection of the presentation parameters and/or evaluation parameters), five selection steps 42a, 42b, 42c, 42d, 42e take place. In a first selection step 42a, a selection of image data of the medical image data set 30 to be displayed takes place. In a second selection step 42b, a selection of a display setting for the medical image data set 40 takes place. In a third selection step 42c, a selection of a greyscale value map and/or color palette for the medical image data set 40 takes place. In a fourth selection step 42d, a segmentation of the medical image data set 40 takes place. In a fifth selection step 42e, a further processing of the medical image data set 40 takes place. Naturally, only individual selection steps of the five selection steps 42a, 42b, 42c, 42d, 42e can also be implemented. As always, individual selection steps of the five selection steps 42a, 42b, 42c, 42d, 42e can also be implemented in a different combination. The selection steps 42a, 42b, 42c, 42d, 42e are thereby implemented by means of the input unit 26, in particular by the first user. The selection steps 42a, 42b, 42c, 42d, 42e thereby take place according to a time sequence. The first selection step 42a thus takes place chronologically before the second selection step 42b, which in turn takes place chronologically before the third selection step 42c etc.

Furthermore, on the basis of the selection steps 42a, 42b, 42c, 42d, 42e a preparation of the medical image data set 40 is respectively implemented by means of the computer 24 in a further method step 43. In a first preparation step 43a, the medical image data set 40 is displayed at the display unit 25 using the selection of the image data to be displayed of the medical image data set 40 in the first selection step 42a. In a second preparation step 43b, the medical image data set 40 is displayed by means of the display unit 25 using the selection of the display setting for the medical image data set 40 in selection step 42b. In a third preparation step 43c, the medical image data set 40 is displayed by means of the display unit 25 using the selection of the greyscale value map and/or color palette for the medical image data set 40 in the third selection step 42c. In a fourth preparation step 43d, the medical image data set 40 is segmented by means of the computer 24 using the segmentation of the medical image data set 40 in the fourth selection step 42d. In a fifth preparation step 43e, the medical image data set 40 is processed further by means of the computer 24 using the selected further processing of the medical image data set 40 in the fifth selection step 42e.

As shown in FIG. 2, a protocoling of the presentation parameters and/or evaluation parameters selected in the selection steps 42a, 42b, 42c, 42d, 42e takes place in a further method step 44 by means of the computer 24. The time sequence of the selection steps 42a, 42b, 42c, 42d, 42e is additionally protocoled in the further method step 44.

In a further method step 45, the medical image data set 40 and the protocoled presentation parameters and/or evaluation parameters, together with the protocoled time sequence of the selection steps 42a, 42b, 42c, 42d, 42e, are provided to a second user by means of the display unit 25.

In a further method step 46, via the input unit 26 the second user implements a modification of the provided protocoled presentation parameters and/or evaluation parameters. He or she modifies the segmentation of the medical image data set 40 that was implemented by the first user in the fourth selection step 42d. In a further method step 47, a second—in particular automatic—preparation of the medical image data set 40 thereby takes place by operation of the computer 24 according to the modification of the presentation parameters and/or evaluation parameters. In the shown case, the medical image data set 40 is segmented again using the segmentation modified by the second user.

Finally, in a further method step 48 the selection steps that are not modified by the second user and that, according to the protocoled time sequence, take place chronologically after the modification run again automatically by means of the computer 24. In the shown example, the fifth selection step 42e (which, according to the time sequence, follows the fourth selection step 42d) thus takes place again, however on the basis of the modified segmentation of the medical image data set 40. In the further method step 48, a second further processing of the medical image data set 40 thus takes place on the basis of the modified segmentation of the medical image data set 40. For this it is not necessary that the second user selects the second further processing (in particular parameters for the second further processing) again. The second further processing of the medical image data set 40 takes place according to the parameters for the further processing that are protocoled in the fifth selection step 42e.

The method steps of the embodiments of the method according to the invention that are shown in FIG. 2 and FIG. 3 are executed by the magnetic resonance apparatus 11, in particular the user interface 32 of the magnetic resonance apparatus 11. For this, the magnetic resonance apparatus 11—in particular the user interface 32 of the magnetic resonance apparatus 11—includes necessary software and/or computer programs that are stored in a memory unit of the magnetic resonance apparatus 11, in particular the user interface 32 of the magnetic resonance apparatus 11. The software and/or computer programs include program means that are designed to (at least partially automatically) execute the method according to the invention when the computer program and/or software is executed in the magnetic resonance apparatus 11 (in particular in the user interface 32 of the magnetic resonance apparatus 11) by means of a processor unit of the magnetic resonance apparatus 11 (in particular of the user interface 32 of the magnetic resonance apparatus 11)

Although modifications and changes may be suggested by those skilled in the art, it is the intention of the inventor to embody within the patent warranted hereon all changes and modifications as reasonably and properly come within the scope of his contribution to the art.

We claim as our invention:

1. A method for processing an image data set, comprising:
providing an image data set to a computer at a first point in time;
selecting a parameter from the group consisting of presentation parameters for said image data set and evaluation parameters for said image data set, as a selected parameter, and entering said selected parameter into said computer;
in said computer, automatically preparing said image data set for presentation or evaluation dependent on said selected parameter;
automatically protocoling the selected parameter; and
from said computer, emitting an electronic output comprising said image data set and said selected parameter at a second point in time that is chronologically after said first point in time.

2. A method as claimed in claim 1 comprising selecting said selected parameter according to a time sequence, and protocoling said selected parameter by protocoling said time sequence.

3. A method as claimed in claim 1 comprising, in said computer, modifying said selected parameter.

4. A method as claimed in claim 1 comprising selecting a presentation parameter as said selected parameter, and with said presentation parameter, selecting image data from said image data set to be displayed.

5. A method as claimed in claim 1 wherein said selection parameter is a presentation parameter and, with said presentation parameter, selecting a display setting for displaying said image data set.

6. A method as claimed in claim 5 comprising selecting, as said display setting, at least one of a greyscale value map and a color palette.

7. A method as claimed in claim 1 comprising selecting an evaluation parameter as said selected parameter and, with said evaluation parameter, segmenting said image data set.

8. A method as claimed in claim 1 wherein said selection parameter is an evaluation parameter, and selecting said evaluation parameter for further processing of said image data set.

9. A user interface comprising:
a computer;
an input unit configured to enter an image data set into said computer at a first point in time;
said input unit being configured to allow selection of a parameter from the group consisting of presentation parameters for said image data set and evaluation parameters for said image data set, as a selected parameter, and to enter said selected parameter into said computer;
said computer being configured to automatically prepare said image data set for presentation or evaluation dependent on said selected parameter;
said computer being configured to automatically protocol the selected parameter;
a display unit; and
said computer being configured to emit an electronic output comprising said image data set and said selected parameter to said display unit at a second point in time that is chronologically after said first point in time, and to cause said image data set and said selected parameter to be displayed together at said display unit.

10. A medical imaging apparatus comprising:
a data acquisition unit in which an examination subject is situated;
a control unit configured to operate said data acquisition unit to acquire medical image data from the examination subject situated in the data acquisition unit;
a user interface comprising an input unit, a computer, and a display unit;
said input unit being configured to enter an image data set, comprising said medical image data into said computer at a first point in time;
said input unit being configured to allow selection of a parameter from the group consisting of presentation parameters for said image data set and evaluation parameters for said image data set, as a selected parameter, and to enter said selected parameter into said computer;
said computer being configured to automatically prepare said image data set for presentation or evaluation dependent on said selected parameter;
said computer being configured to automatically protocol the selected parameter; and
said computer being configured to emit an electronic output comprising said image data set and said selected parameter to said display at a second point in time that is chronologically after said first point in time, and to cause said image data set and said selected parameter to be displayed together at said display unit.
